(19) United States
(12) Patent Application Publication
(10) Pub. No.: US 2005/0102100 A1
(43) Pub. Date: May 12, 2005

(54) Navigation system

(75) Inventor: Masatsugu Norimoto, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI DENKI KABUSHIKI KAISHA

(21) Appl. No.: 10/959,396

(22) Filed: Oct. 7, 2004

(30) Foreign Application Priority Data
Nov. 7, 2003 (JP) 2003-378497

(51) Int. Cl. G01C 21/34

(52) U.S. Cl. 701/209; 340/995.19

(57) ABSTRACT

A navigation system includes: a map data storage device that stores map data including a not-yet-checked area having roads not yet checked for navigability; a path search processing block that searches a path to a destination based on the map data stored in the map data storage device; a map display block that does not make roads in the not-yet-checked area objects to be displayed when the path searched by the path search processing block does not pass the not-yet-checked area, and that makes only roads constructing the path of the roads in the not-yet-checked area objects to be displayed when the path passes the not-yet-checked area; and a screen display device that displays the roads, which are made the objects to be displayed by the map display block based on the map data in the map data storage device.

### BACKGROUND OF THE INVENTION

1. Field of the Invention

The present invention relates to a navigation system and in particular, to a technology for displaying roads in a not-yet-checked area in which it is not yet checked whether or not roads are navigable.

2. Description of the Related Art

A navigation system that is mounted on a vehicle and guides a driver to a destination, has been known. In this navigation system, first, a path from the present position of a vehicle to a destination is searched on the basis of map data. This searched path is superposed on a map displayed on a display screen in conjunction with the present position of the vehicle on the basis of the map data. Because the driver can drive the vehicle while looking at the display screen and checking the present position of the vehicle, and hence the driver can surely arrive at the destination in a shortest time without losing his way.

By the way, roads displayed by the map data used in the navigation system like the above described, include not only checked roads that had been already checked for navigability but also not-yet-checked roads that has not yet been checked for navigability. As for the area including such not-yet-checked roads (hereinafter it is reffered to “not-yet-checked area”), a conventional navigation system displays the roads in the not-yet-checked area by means of the following method.

That is, roads in the not-yet-checked area are also displayed at all times in the same way as the roads in a checked area in which it has already been checked that roads are navigable. However, when a searched path passes a not-yet-checked area because a destination or a midway point is in the not-yet-checked area, the path is displayed or guided only in a checked area and in the not-yet-checked area, the path is not displayed or not guided but only the direction of the destination is displayed by a straight line.

In this regard, as a technology relating to this, patent document 1 discloses a navigation device for a mobile body in which a present position of the mobile body can be checked with reliability by a screen display. In this navigation device, roads between a departure point and a destination, both of which are input by an operation input block, are searched by a path search block and a recommended path is displayed and information data which does not relate to the recommended path is erased from the screen of a display block. Moreover, more detailed data which relates to the recommended path and is stored in a map data storage block, is additionally displayed. On the other hand, the present position of the mobile body is calculated and estimated by a mobile body position detection block on the basis of signals from a distance sensor and a direction sensor and the map data, and still more detailed data around the present position of the mobile body is displayed in addition.

Further, patent document 2 discloses the map display device of a navigation system in which only necessary detailed roads are displayed. This map display device of the navigation system specifies on which map a present position of the system locates by a map matching processing and displays a detailed road when the present position is on the detailed road. In this case, the detailed road is limited to one within a closed region which is surrounded by main roads. When the vehicle returns to the main road, displaying the detailed road is stopped and ordinary display for roads is displayed.
[Patent document 1] Japanese Unexamined Patent Publication No. 4-336592
[Patent document 2] Japanese Unexamined Patent Publication No. 8-68647

In the conventional navigation systems described above, the paths are distinctively displayed and guided in such a way that the paths are displayed and guided only within a checked area and are not displayed and not guided in the not-yet-checked area. However, since the road map of the not-yet-checked area is always displayed, not-yet-checked road information is always supplied to drivers, which lacks in adequacy and validity.

Moreover, in the not-yet-checked area, information relating to the destination is only direction information displayed by a straight line. Hence, it is difficult for driver to judge which path he should take to go to the destination.

### SUMAMRY OF THE INVENTION

The present invention has been made to solve the above described problems and the object of the present invention is to provide a navigation system that can reduce the risk of showing a driver erroneous information and can show the driver with minimum road information required for the driver to arrive at a destination.

A navigation system in accordance with the present invention includes: a map data storage device that stores map data including a not-yet-checked area having roads that are not yet checked for navigability; a path search processing block that searches a path from a predetermined position to a destination on the basis of the map data stored in the map data storage device; a map display block that does not make roads in the not-yet-checked area objects to be displayed when the path searched by the path search processing block does not pass the not-yet-checked area, and that makes only roads constructing the path of the roads in the not-yet-checked area objects to be displayed when the path searched by the path search processing block passes the not-yet-checked area; and a screen display device that displays the roads, which are made the objects to be displayed by the map display block, on the basis of the map data stored in the map data storage device.

By this arrangement, according to the present invention, when the path searched by the path search processing block does not pass the not-yet-checked area, roads in the not-yet-checked area are not made objects to be displayed, and when the path searched by the path search processing block passes the not-yet-checked area, only roads constructing the path of the roads in the not-yet-checked area are made objects to be displayed. Hence, in a usual condition where the driver drives in a checked area, roads in the not-yet-checked area in which roads are not checked for navigability are not displayed. Therefore, it is possible to reduce the risk of showing a driver erroneous information. On the other hand, when the driver passes the not-yet-checked area, the path in the not-yet-checked area is displayed. Hence, it is possible to show the driver with minimum road information required for the driver to arrive at a destination.

Further, a navigation system in accordance with the present invention includes: a map data storage device that stores map data including a not-yet-checked area having roads that are not checked for navigability; a path search processing block that searches a path from a predetermined position to a destination on the basis of the map data stored in the map data storage device; a map display block that does not make roads in the not-yet-checked area objects to be displayed, when the path searched by the path search processing block does not pass in the not-yet-checked area, and that makes only roads constructing the path of the roads in the not-yet-checked area and roads, which are connected to the roads constructing the path and exist within a predetermined range, objects to be displayed, when the path searched by the path search processing block passes in the not-yet-checked area; and a screen display device that displays the roads, which are made the objects to be displayed by the map display block, on the basis of the map data stored in the map data storage device.

By this arrangement, according to the present invention, when the path searched by the path search processing block does not pass the not-yet-checked area, roads in the not-yet-checked area are not made objects to be displayed, and when the path searched by the path search processing block passes the not-yet-checked area, only roads constructing the path of the roads in the not-yet-checked area and roads which are connected to the roads constructing the path and exist within a predetermined range, are made objects to be displayed. Hence, in a usual condition where the driver drives in a checked area, roads in the not-yet-checked area in which the roads are not checked for navigability are not displayed. Hence, it is possible to reduce the risk of showing a driver erroneous information. On the other hand, when the driver passes the not-yet-checked area the path in the not-yet-checked area and roads, which are connected to the path and exist within a predetermined range, are displayed. Hence, even if the displayed path in the not-yet-checked area includes a portion that is not navigable, the driver is provided with a hint to take an alternative path, so that the driver can easily drive in the not-yet-checked area.

Still further, a navigation system in accordance with the present invention includes: a map data storage device that stores map data including a not-yet-checked area having roads that are not yet checked for navigability; a vehicle position detection block that detects a position of a vehicle; a map display block that does not make roads in the not-yet-checked area objects to be displayed, when the present position detected by the vehicle position detection block is outside the not-yet-checked area, and that makes only roads, which exist within a predetermined range from a position where the vehicle exists, objects to be displayed, when the present position detected by the vehicle position detection block is inside the not-yet-checked area; and a screen display device that displays the roads, which are made the objects to be displayed by the map display block, on the basis of the map data stored in the map data storage device.

By this arrangement, according to the present invention, when the present vehicle position is outside the not-yet-checked area, roads in the not-yet-checked area are not made objects to be displayed, and when the present vehicle position is inside the not-yet-checked area, only roads existing within a predetermined range from a position where the vehicle exists of the roads in the not-yet-checked area are made objects to be displayed. Hence, in a usual condition where the driver drives in a checked area, roads in the not-yet-checked area in which the roads are checked for navigability are not displayed. Therefore, it is possible to reduce the risk of showing the driver with erroneous information. On the other hand, when the driver passes the not-yet-checked area, the roads within a predetermined range from the present position of the vehicle is displayed, so that the driver can easily drive in the not-yet-checked area.

### BRIEF DESCRIPTION OF THE DRAWINGS

FIG. 1 is a block diagram to show the structure of a navigation system in accordance with embodiment 1 of the present invention.

FIG. 2 is a flow chart to show a map display processing performed by the navigation system in accordance with embodiment 1 of the present invention.

FIGS. 3(A) and (B) are illustrations to show an example of maps displayed on a screen display device of a conventional navigation system.

FIGS. 4(A) and (B) are illustrations to show an example of maps displayed on a screen display device of the navigation system in accordance with embodiment 1 of the present invention.

FIG. 5 is a flow chart to show a map display processing performed by a navigation system in accordance with embodiment 2 of the present invention.

FIGS. 6(A) and (B) are illustrations to show an example of maps displayed on a screen display device of the navigation system in accordance with embodiment 2 of the present invention.

FIG. 7 is a flow chart to show a map display processing performed by a navigation system in accordance with embodiment 3 of the present invention.

FIGS. 8(A) and (B) are illustrations to show an example of maps displayed on the screen display device of the navigation system in accordance with embodiment 3 of the present invention.

### DETAILED DESCRIPTION OF THE PREFERRED EMBODIMENTS

Hereafter, the preferred embodiments of the present invention will be described in detail with reference to the drawings.

### Embodiment 1

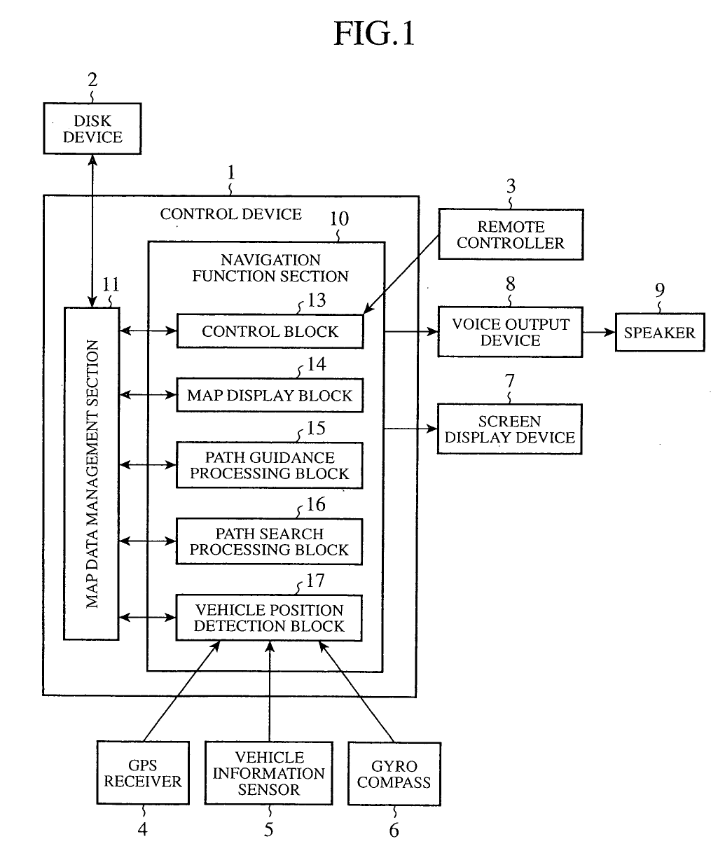

FIG. 1 is a block diagram to show the structure of a navigation system in accordance with embodiment 1 of the present invention. This navigation system is made up of a control device 1, a disk device 2, a remote controller 3, a Grobal Positioning System (GPS) receiver 4, a vehicle information sensor 5, a gyro compass 6, a screen display device 7, a voice output device 8, and a speaker 9.

The control device 1 is structured of, for example, a microprocessor. This control device 1 is made up of a navigation function section 10 and a map data management section 11. The navigation function section 10 is provided with a control block 13, a map display block 14, a path guidance processing block 15, a path search processing block 16, and a vehicle position detection block 17. The respective blocks will be described later in detail.

The disk device 2 corresponds to the map data storage device of the present invention. When a recording medium having map data, music data, and image data recorded thereon is loaded in the disk device 2, the disk device 2 reproduces its recording content. As the recording medium, for example, a CD (Compact Disk) or a DVD (Digital Versatile Disk) and the like is used. The map data, the music data, the image data and the like which are reproduced by this disk device 2 are sent to the control device 1.

At this point the map date recorded on the recording medium will be described. The map data is basically made up of a set of nodes each of which correspondes to an intersection and road links each of which correspondes to a road connecting two intersections (nodes). Each of a couple of nodes or road link is provided with attribute information to show whether or not the couple of nodes or the road link belongs to a not-yet-checked area. At this point the “not-yet-checked area” means an area including nodes and road links that have not yet been checked for navigability. In this regard, an area including nodes and road links that have already been checked for navigability is called a “checked area”.

A map displayed on the screen display device 7 is composed with a map unit that is a unit for map management. In this navigation system, a map display processing is performed for each map unit. Each of the map units there is previously provided with attribute information to show whether or not a not-yet-checked area is included in the map unit.

The remote controller 3 is composed of, for example, an infrared transmitter and is used by drivers to give the navigation system with various kind of commands. The command from the remote controller 3 is sent to the control block 13 included in the navigation function section 10 of the control device 1.

The GPS receiver 4 receives a signal from a GPS satellite to detect the present position of a vehicle. Data to show the present position of the vehicle, which is detected by the GPS receiver 4, is sent to the vehicle position detection block 17 included in the navigation function section 10 of the control device 1.

The vehicle information sensor 5 is composed of, for example, a speed sensor to detect the moving speed of the vehicle. Data to show the moving speed of the vehicle, which is detected by the vehicle information sensor 5, is sent to the vehicle position detection block 17 included in the navigation function section 10 of the control device 1.

The gyro compass 6 detects direction for which the vehicle heads. Data to show the direction for which the vehicle heads, which is detected by the gyro compass 6, is sent to the vehicle position detection block 17 included in the navigation function section 10 of the control device 1.

The screen display device 7 is composed of, for example, a liquid crystal display (LCD) to display information such as map, path, vehicle position mark and the other messages in accordance with display data which is sent from the navigation function section 10 of the control device 1.

The voice output device 8 produces a voice signal in accordance with voice data which is sent from the navigation function section 10 of the control device 1 and sends the voice signal to the speaker 9. The speaker 9 converts the voice signal which is sent from the voice output device 8 to voice and outputs the voice. By this arrengment, various kind of guiding messages with the voice are generated by the speaker 9 produces.

Next, the control device 1 will be described in detail. The control device 1, as described above, is composed of the navigation function section 10 and the map data management section 11.

The map data management section 11 reads map data from the disk device 2 in response to a request from the navigation function section 10 and processes the map data according to necessity, and then sends the map data to the navigation function section 10.

The navigation function section 10, as described above, is composed of the control block 13, the map display block 14, the path guidance processing block 15, the path search processing block 16, and the vehicle position detection block 17.

The control block 13 receives a driver request which is sent from the remote controller 3 and controls the whole navigation function section 10. The contents of control performed by the control block 13 will be described later in detail.

The map display block 14 produces display data to display a map on the basis of the map data which is acquired from the map data management section 11 and sends the display data to the screen display device 7. The map display block 14 will be described later in detail.

The path guidance processing block 15 acquires the map data from the map data management section 11 and performs a processing to display a path. The path guidance processing block 15 returns the map data subjected to the processing for displaying a path to the map data management section 11.

The path search processing block 16 acquires the map data from the map data management section 11 and performs a path search processing and returns a searched path to the map data management section 11.

The vehicle position detection block 17 detects the present position of the vehicle on the basis of data sent from the GPS receiver 4, speed data sent from the vehicle information sensor 5 and direction data sent from the gyro compass 6, and sends the detected present position of the vehicle as present vehicle position data to the map data management section 11.

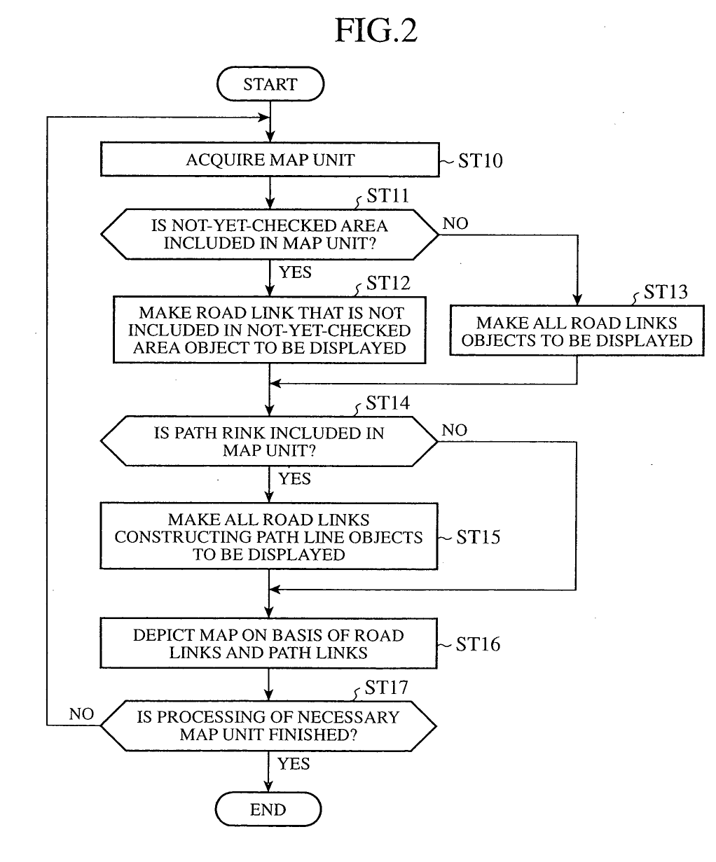

Next, a map display processing performed in the navigation system in accordance with embodiment 1 of the present invention, which is composed in a manner described above, will be described with reference to a flow chart shown in FIG. 2.

In this regard, it is assumed that before this map display processing is performed, a path from a departure position to a destination has been already searched by the path search processing block 16 and the result is stored as path line information in the map data management section 11. The path line information is composed of road links which composes the path and the road links which are included in the path are called the path links. Further, it is assumed that destination data to show a destination, which is used for searching the path, has also been stored in the map data management section 11. Still further, it is assumed that vehicle position data detected by the vehicle position detection section 17 has also been stored in the map data management section 11.

In the map display processing, first, one map unit is acquired (step ST10). To be specific, the map data management section 11 reads one map unit from the disk device 2 and sends the map unit to the map display block 14. Next, the map display block 14 checks whether or not a not-yet-checked area is included in the map unit which is read at step ST10 (step ST11). This is performed by checking the attribute information (attribute information to show whether or not a not-yet-checked area is included in the map unit) which is added to the map unit.

If it is determined at this step ST11 that a not-yet-checked area is included in the map unit, a processing for making a road link that is not included in the not-yet-checked area an object to be displayed is performed (step ST12). To be specific, attribute information (attribute information to show whether or not a road link is a not-yet-checked road link) which is previously added to all road links in the map unit, is checked and road links other than not-yet-checked road links are selected as objects to be displayed. On the other hand, if it is determined at this step ST11 that a not-yet-checked area is not included in the map unit, a processing for making all road links objects to be displayed is performed (step ST13). That is, all road links in the map unit are selected as objects to be displayed.

Next, it is checked whether or not a path link is included in the map unit acquired at step ST11 (step ST14). That is, the map display block 14 reads path line information which is stored in the map data management section 11 and checks whether or not a path link constructing the path line information is included in the map unit.

If it is determined at this step ST14 that a path link is included in the map unit, a processing for making all road links (path links) which compose the path line objects to be displayed is performed (step ST15). By this arrangement, all the path line is selected as an object to be displayed irrespective of whether the path line passes in the not-yet-checked area or not. If it is determined at this step ST14 that a path link is not included in the map unit, the processing at step ST15 is skipped.

Because the attribute information to show whether or not a not-yet-checked area is included in a map unit, is previously added to the map unit in this manner, if it is found by referring to the attribute information that a not-yet-checked area is not included in the map unit, it is not necessary to check all road links in the map unit. Hence, the screen display processing can be performed effectively and quickly.

Next, a processing of depicting a map is performed on the basis of road links and path links (step ST16). That is, the map display block 14 produces display data on the basis of the road links selected as the objects to be displayed by the processings at steps ST10 to ST13, the path links acquired by the processing at steps ST14 and ST15, and vehicle position data and destination data that are stored in the map data management section 11 and sends the display data to the screen display device 7.

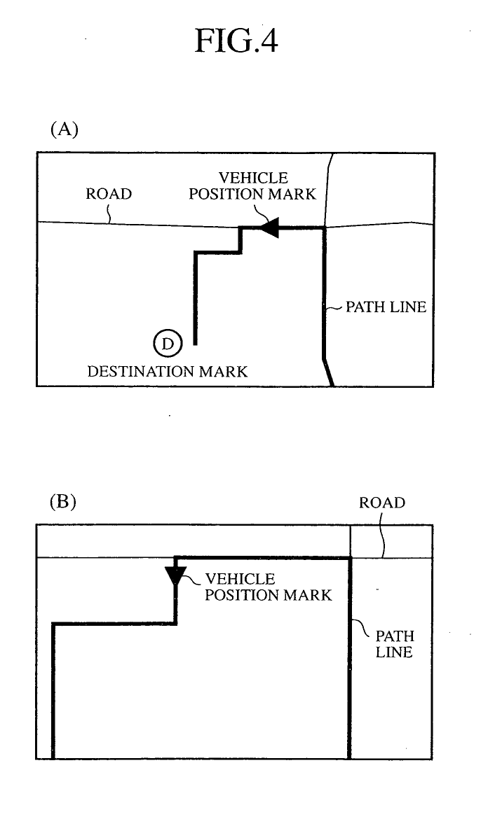

Next, it is checked whether or not a processing of a map unit necessary for screen display is completed (step ST17). If itis determined that the processing for a map unit is not completed, the sequence is returned to step ST10 where the next map unit is acquired. Then, the above described processings are repeatedly performed. Then, if it is determined at step ST17 that the processing for all necessary map units is completed, the maps as shown in FIG. 4(A) and in FIG. 4(B) which is an enlarged view of FIG. 4(A), are displayed on the screen of the screen display device 7 and the screen display processing is finished.

At this point the map displayed on the screen display device 7 by the above described processings will be explained in comparison with a map displayed on the screen display device of a conventional navigation system.

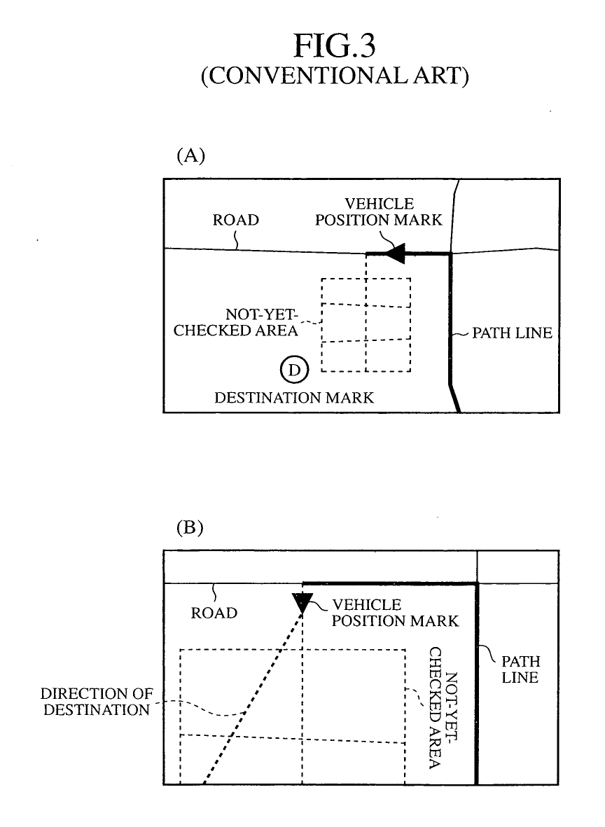

FIG. 3(A) is illustrations to show an example of a map displayed on the screen display device of a conventional navigation system. In this map roads in a checked area which are shown by solid lines, roads in a not-yet-checked area which are shown by broken lines, path lines which are shown by thick lines, a vehicle position mark and a destination mark are included. As shown in FIG. 3(A), a path line is not depicted for a road in the not-yet-checked area. Hence, the driver is required to select an arbitrary path by his own responsibility from among many paths in the not-yet-checked area to go to a destination.

FIG. 3(B) is an illustration to show another example of a map displayed on the screen display device of the conventional navigation system. In this map, a straight line (which is shown by dotted line) to show the direction of the destination is added to the map shown in FIG. 3(A). Hence, the driver is required to select an arbitrary path by his own responsibility from among many paths in the not-yet-checked area while referring to the direction of the destination to go to a destination.

In contrast to the drawings, in a map displayed on the screen display device of the navigation system in accordance with embodiment 1 of the present invention, as shown in FIG. 4(A) and FIG. 4(B), roads in a checked area which are shown by solid lines, path lines which are shown by thick lines, a vehicle position mark and a destination mark are included. The path lines are shown also for the roads in the not-yet-checked area but the other roads in the not-yet-shown area are not shown.

As described above, according to the navigation system in accordance with embodiment 1 of the present invention, the path lines are shown also for the roads in the not-yet-checked area but the other roads in the not-yet-checked area are not shown. Hence, it is possible to reduce the risk of showing a driver erroneous information and can show the driver with minimum road information required for the driver to arrive at a destination.

In this regard, the navigation system in accordance with embodiment 1 described above is so arranged as to display path lines in the checked area and path lines in the not-yet-checked area without making any distinction between them in particular. However, it is also recomendable to arrange the navigation system in such a way that the path lines in the not-yet-checked area are displayed in a manner different from a manner displaying the path lines in the checked area, for example, by different colors or by different kinds of lines. According to this arrangement, the driver can drive the vehicle while recognizing that roads in the not-yet-checked area might be not navigable and hence the driver can easily respond to the occurrence of unexpected events.

### Embodiment 2

A navigation system in accordance with embodiment 2 of the present invention is arranged to show not only path lines in the not-yet-checked area but also other roads which are connected to the path lines, existing within a predetermined range.

The structure of the navigation system in accordance with embodiment 2 of the present invention is quite the same as the navigation system in accordance with embodiment 1 of the present invention shown in FIG. 1.

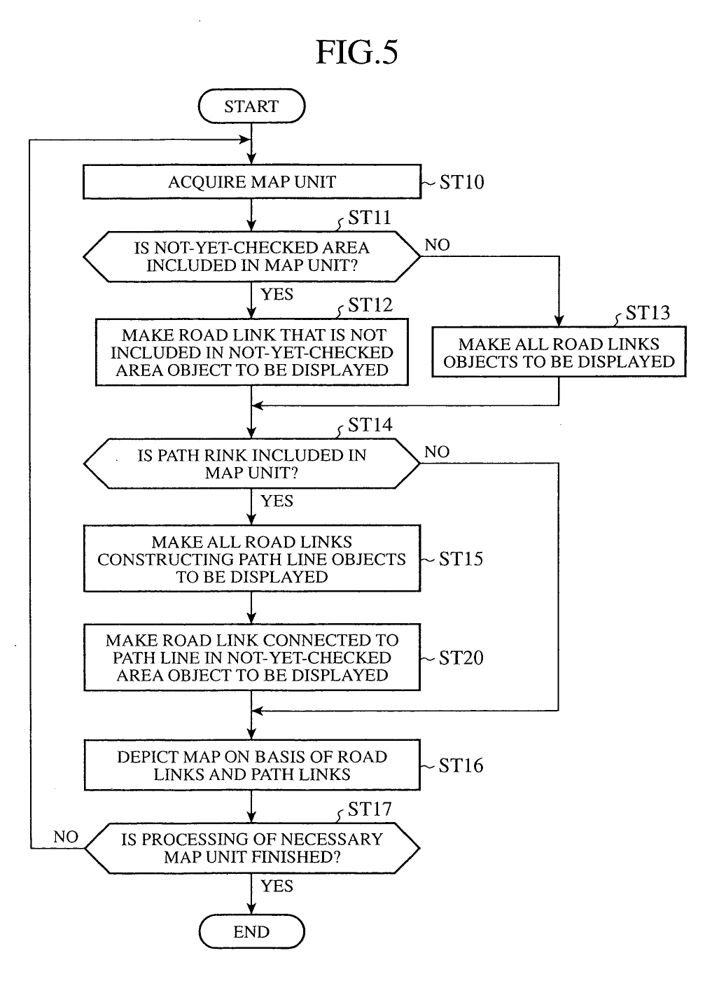

Next, a map di splay processing performed by the navigation system in accordance with embodiment 2 of the present invention will be described with reference to a flow chart shown in FIG. 5. In this regard, in the following description, the same steps as the steps in the map display processing of the navigation system in accordance with embodiment 1 described above, are denoted by the same reference symbols and will be simply described and different steps will be mainly described in detail.

In the following description, as with the screen display processing in the navigation system in accordance with embodiment 1 described above, it is assumed that before this map display processing is performed, a path from a departure position to a destination has been already searched by the path search processing block 16 and the result is stored as path line information in the map data management section 11. Further, it is assumed that destination data to show a destination, which is used for searching the path, has also been stored in the map data management section 11. Still further, it is assumed that vehicle position data detected by the vehicle position detection section 17 has also been stored in the map data management section 11.

In the map display processing, first, one map unit is acquired (step ST10). Next, the map display block 14 checks whether or not a not-yet-checked area is included in the map unit which is read at step ST10 (step ST11). If it is determined at this step ST11 that a not-yet-checked area is included in the map unit, a processing for making a road link that is not included in the not-yet-checked area an object to be displayed is performed (step ST12). On the other hand, if it is determined at this step ST11 that a not-yet-checked area is not included in the map unit, a processing for making all road links objects to be displayed is performed (step ST13).

Next, it is checked whether or not a path link is included in the map unit acquired at step ST11 (step ST14). If it is determined at this step ST14 that a path link is included in the map unit, a processing for making all road links (path links) which compose the path line objects to be displayed is performed (step ST15).

Next, a processing for making road links which are connected to path lines in the not-yet-checked area objects to be displayed, is performed (step ST20). To be specific, road links which are connected to all path links constructing the path lines, that are made objects to be displayed at step ST 15, are selected as objects to be displayed. In this case, all road links which are connected to the path links, can be made objects to be displayed. Alternatively, it may be also recommendable that one road link or a plurality of road links which is or are further connected to all respective road links connected to the path links and which exists or exist within a predetermined distance from the path links, can be selected as an object or objects to be displayed. According to this arrangement, in a case where road links which are connected to the path links, are short, road links further connected to the road links are also displayed. Hence, the driver can easily recognize the conditions of roads around the path lines. If it is determined at step 14 that the path link is not included in the map unit, the processings at steps ST15 and ST20 are skipped.

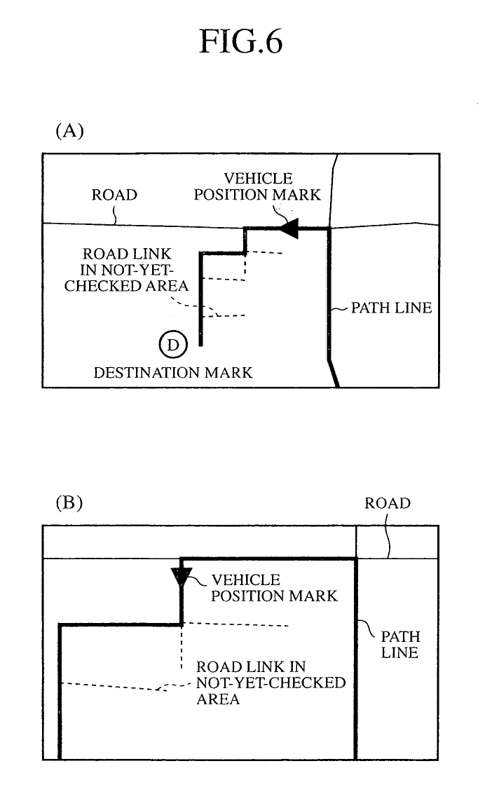

Next, a processing of depicting a map is performed on the basis of road links and path links (step ST16). Next, it is checked whether or not a processing of a map unit necessary for screen display is completed (step ST17). If it is determined that the processing of a map unit is not completed, the sequence is returned to step ST10 where the next map unit is acquired. Then, the above described processings are repeatedly performed. Then, if it is determined at step ST17 that the processing of a necessary map unit is completed, a map as shown in FIG. 6(A) and in FIG. 6(B), which is an enlarged view of FIG. 6(A), is displayed on the screen of the screen display device 7 and the screen display processing is finished.

The map displayed on the screen display device 7, as shown in FIGS. 6(A) and 6(B), includes roads in the checked area which are shown by solid lines, path lines which are shown by thick lines, roads in the not-yet-checked area which are shown by broken lines, a vehicle position mark, and a destination mark. The path lines are shown also for the roads in the not-yet-checked area, but as for the other roads in the not-yet-checked area, only road links connected to the path lines are shown.

As described above, according to the navigation system in accordance with embodiment 2 of the present invention, the path lines are shown also for the roads in the not-yet-checked area and as for the other roads in the not-yet-shown area, only roads connected to the path lines are shown. Hence, it is possible to reduce the risk of showing a driver erroneous information and to provide the driver with the conditions of the neighboring roads necessary for the driver to drive the vehicle even when the driver enters into the not-yet-checked area.

In this regard, the navigation system in accordance with embodiment 2 described above is so arranged as to display path lines in the checked area and path lines in the not-yet-checked area without making any distinction between them in particular. However, it is also recomendable to arrange the navigation system in such a way that the path lines in the not-yet-checked area are displayed in a manner different from a manner displaying the path lines in the checked area, for example, by different colors or by different kinds of lines. According to this arrangement, the driver can drive the vehicle while recognizing that roads in the not-yet-checked area might be not navigable and hence the driver can easily respond to the occurrence of unexpected events.

Moreover, the roads connected to the paths in the not-yet-checked area can be so composed as to be displayed only when the vehicle enters within a predetermined range from the entrance of the path in the not-yet-checked area and when the vehicle is in the not-yet-checked area. According to this arrangement, in a usual state where the vehicle runs in the checked area, roads in the not-yet-checked area are not displayed, so that the risk of showing the driver erroneous information can be reduced.

### Embodiment 3

A navigation system in accordance with embodiment 3 of the present invention is arranged to show road links around a vehicle which is existing in the not-yet-checked area even if there is not a path line.

The structure of the navigation system in accordance with embodiment 3 of the present invention is quite the same as the navigation system in accordance with embodiment 1 of the present invention shown in FIG. 1.

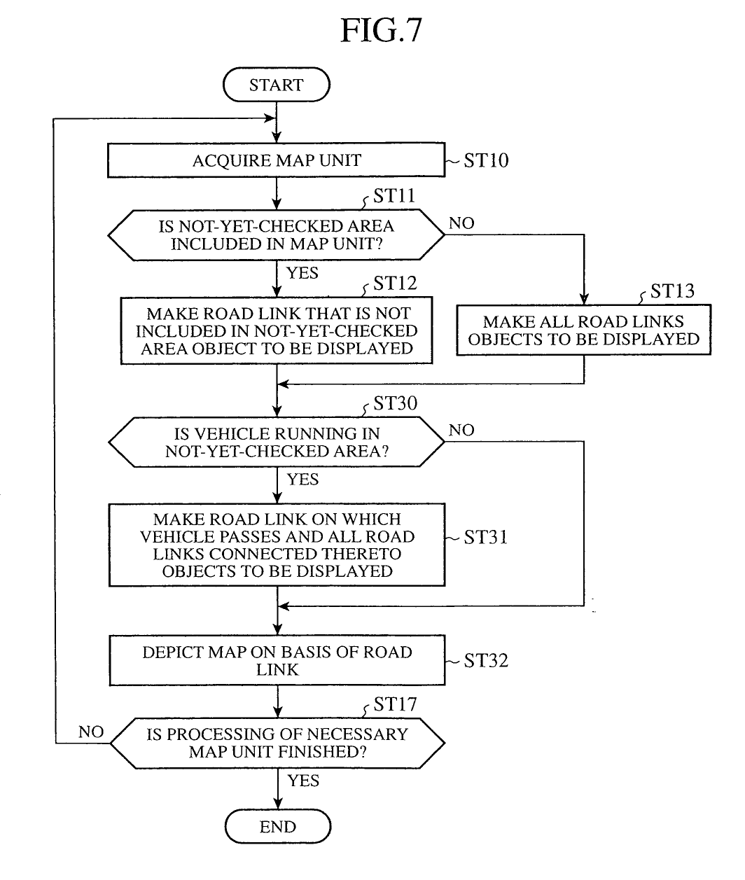

Next, a map display processing performed by the navigation system in accordance with embodiment 3 of the present invention will be described with reference to a flow chart shown in FIG. 7. In this regard, in the following description, the same steps as the steps in the map display processing of the navigation system in accordance with embodiment 1 described above, are denoted by the same reference symbols and will be simply described and different steps will be mainly described in detail.

In the following description, it is assumed that before this map display processing is performed, destination data to show a destination is stored in the map data management section 11 by the path search processing block 16 before this map display processing is performed. Further, it is assumed that the present position data of the vehicle detected by the vehicle position detection section 17 is also stored in the map data management section 11.

In the map display processing, first, one map unit is acquired (step ST10). Next, the map display block 14 checks whether or not a not-yet-checked area is included in the map unit which is read at step ST10 (step ST11). If it is determined at this step ST11 that a not-yet-checked area is included in the map unit, a processing for making a road link that is not included in the not-yet-checked area an object to be displayed is performed (step ST12). On the other hand, if it is determined at this step ST11 that a not-yet-checked area is not included in the map unit, a processing for making all road links objects to be displayed is performed (step ST13).

Next, it is checked whether or not the vehicle is running in the not-yet-checked area (step ST30). To be specific, the map display block 14 checks whether or not road link of the present position shown by the present position data which is read from the map data management section 11, includes attribute information to the effect that the road link belongs to the not-yet-checked area.

If it is determined at this step ST30 that the vehicle is running in the not-yet-checked area, next, a processing of making the road link where the vehicle is running and all road links which are connected to this road link objects to be displayed, is performed (step ST31). In this case, all road links which are connected to the road link where the vehicle is running can be made objects to be displayed. Alternatively, it may be also recommendable that one road link or a plurality of road links which is or are further connected to all respective road links connected to the road link where the vehicle is running and that exists or exist within a predetermined distance from the road link where the vehicle is running, is or are selected as an object or objects to be displayed. According to this structure, in a case where the road links connected to the road link where the vehicle is running are short, the road links further connected to these road links are also displayed. Hence, the driver can easily recognize the conditions of roads around the path lines. If it is determined at step 30 that the vehicle is not running in the not-yet-checked area, the processing at step ST31 is skipped.

Next, a processing of depicting a map is performed on the basis of the road links (step ST32). To be specific, the map display block 14 produces display data on the basis of the road links selected as the objects to be displayed by the processings at steps ST10 to ST13, the load links in the not-yet-checked area acquired by the processings at steps ST30 and ST31, and the vehicle position data and the destination data that are stored in the map data management section 11, and sends the display data to the screen display device 7.

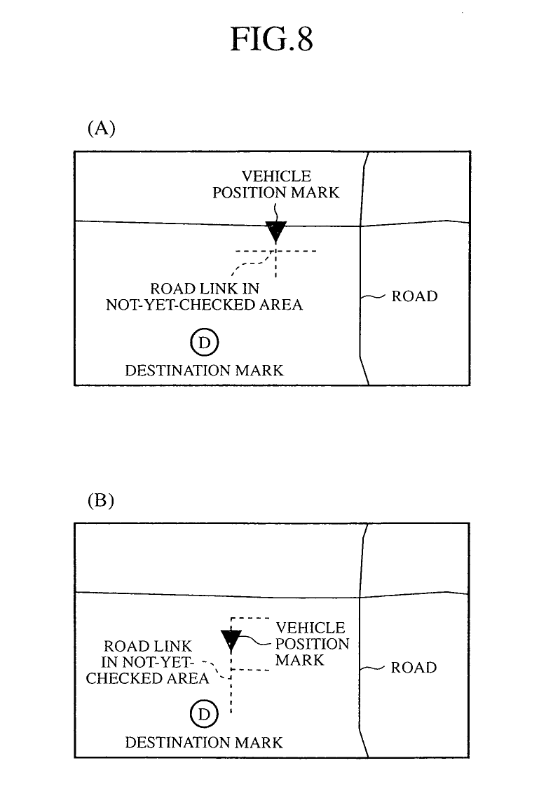

Next, it is checked whether or not a processing of a map unit necessary for screen display has been completed (step ST17). If it is determined that the processing of a map unit has not been completed, the sequence is returned to step ST10 where the next map unit is acquired. Then, the above described processings are repeatedly performed. Then, if it is determined at step ST17 that the processing of a necessary map unit has been completed, a map as shown in FIG. 8(A) or in FIG. 8(B), which is an enlarged view of FIG. 8(A), is displayed on the screen of the screen display device 7 and the screen display processing is finished.

The map displayed on the screen display device 7, as shown in FIGS. 8(A) and 8(B), includes the roads in the checked area which are shown by solid lines, the roads in the not-yet-checked area which are shown by broken lines, the vehicle position mark, and the destination mark. The path line is not shown and as for the roads in the not-yet-checked area, only the road link where the vehicle is running and the road links connected to this road link are shown.

As described above, according to the navigation system in accordance with embodiment 3 of the present invention, it is arranged that the path line is not shown and as for the roads in the not-yet-shown area, only the road link where the vehicle is running and the road links connected to this road link are shown. Hence, it is possible to reduce the risk of showing a driver erroneous information and can show the driver with the conditions of the neighboring roads necessary for the driver to drive the vehicle even when the driver enters the not-yet-checked area.

At this point, for the navigation system in accordance with embodiment 3 described above, it is also recomendable to arrange the navigation system in such a way that roads connected to the path in the not-yet-checked area are displayed only when the vehicle enters a predetermined range from the entrance of the path of the not-yet-checked area and when the vehicle is in the not-yet-checked area. According to this arrangement, in a usual state where the vehicle runs in the checked area, roads in the not-yet-checked area are not displayed, so that the risk of showing the driver erroneous information can be reduced.

1. A navigation system comprising:
a map data storage device that stores map data including a not-yet-checked area having roads that are not yet checked for navigability;
a path search processing block that searches a path from a predetermined position to a destination on the basis of the map data stored in the map data storage device;
a map display block that does not make roads in the not-yet-checked area objects to be displayed when the path searched by the path search processing block does not pass in the not-yet-checked area, and that makes only roads constructing the path of the roads in the not-yet-checked area objects to be displayed when the path searched by the path search processing block passes in the not-yet-checked area; and
a screen display device that displays the roads which are made the objects to be displayed by the map display block on the basis of the map data stored in the map data storage device.

2. A navigation system comprising:
a map data storage device that stores map data including a not-yet-checked area having roads that are not yet checked for navigability;
a path search processing block that searches a path from a predetermined position to a destination on the basis of the map data stored in the map data storage device;
a map display block that does not make roads in the not-yet-checked area objects to be displayed when the path searched by the path search processing block does not pass in the not-yet-checked area, and that makes only roads constructing the path of the roads in the not-yet-checked area and roads which are connected to the roads constructing the path and exist within a predetermined range, objects to be displayed when the path searched by the path search processing block passes in the not-yet-checked area; and
a screen display device that displays the roads which are made the objects to be displayed by the map display block on the basis of the map data stored in the map data storage device.

3. The navigation system as claimed in claim 2, wherein the roads which are connected to the roads constructing the path of the roads in the not-yet-checked area and exist within a predetermined range, are one or a plurality of road links further connected to all road links connected to roads constructing the path and exist within a predetermined distance from the roads constructing the path.

4. The navigation system as claimed in claim 1, wherein the roads constructing the path of the roads in the not-yet-checked area are displayed in a manner different from a manner displaying roads constructing the path of roads that are not included in the not-yet-checked area.

5. The navigation system as claimed in claim 2, wherein the roads constructing the path of the roads in the not-yet-checked area are displayed in a manner different from a manner displaying roads constructing the path of roads outside the not-yet-checked area.

6. A navigation system comprising:
a map data storage device that stores map data including a not-yet-checked area having roads that are not yet checked for navigability;
a vehicle position detection block that detects a present position of a vehicle;
a map display block that does not make roads in the not-yet-checked area objects to be displayed when the present position detected by the vehicle position detection block is outside the not-yet-checked area, and that makes only roads which exist within a predetermined range from the present position where the vehicle exists, objects to be displayed when the present position detected by the vehicle position detection block is inside the not-yet-checked area; and
a screen display device that displays the roads which are made the objects to be displayed by the map display block on the basis of the map data stored in the map data storage device.

7. The navigation system as claimed in claim 6, wherein the roads existing within a predetermined range from the present position where the vehicle exists of the roads in the not-yet-checked area are one or a plurality of road links further connected to all respective road links connected to a road link where the vehicle exists and exist within a predetermined distance from a road where the vehicle exists.
